(19) United States
(12) Patent Application Publication
(10) Pub. No.: US 2025/0283224 A1
(43) Pub. Date: Sep. 11, 2025

(54) UNIVERSAL CATHODIC PROTECTION SYSTEM

(71) Applicant: PETRÓLEO BRASILEIRO S.A. - PETROBRAS, Rio de Janeiro (BR)

(72) Inventors: VINICIUS DA SILVA LEAL AZEVEDO CORREIA, Macaé (BR); Jader Macartney Santos Guerra, Macaé (BR); Yonathan Robeh, Macaé (BR); Andre Joviniano Lins, Macaé (BR)

(21) Appl. No.: 19/072,545

(22) Filed: Mar. 6, 2025

(30) Foreign Application Priority Data
Mar. 7, 2024 (BR) 1020240045939

(51) Int. Cl. C23F 13/18; C23F 13/16; F16L 58/00; F17D 5/00

(52) U.S. Cl. CPC C23F 13/18; C23F 13/16; F16L 58/00; F17D 5/00

(57) ABSTRACT

The present invention is applied in the technical field of subsea interconnection and relates to a universal cathodic protection system aimed at ensuring the integrity of pipelines and umbilicals applied in reuse projects, providing cathodic protection to these assemblies, commonly used in the oil and gas sector. Specifically, the present invention relates to a universal cathodic protection system comprising: a set of links surrounding a portion of a pipeline; and a closure; wherein links of the set of links are connected in sequence to each other to form an adjustable collar around the portion of the pipeline; wherein each link has a sacrificial anode to provide cathodic protection to the pipeline by means of electrical connection thereto; the closure being used to perform the locking and electrical continuity of the system around the pipeline by connecting to the two most extreme links of the set of links.

### CROSS-REFERENCE TO RELATED APPLICATIONS

This application claims priority to Brazilian Application No. BR 1020240045939, filed on Mar. 7, 2024, the disclosure of which is herein incorporated by reference in its entirety.

### FIELD

The present invention is applied in the technical field of submarine interconnection and, more particularly, relates to a universal cathodic protection system aimed at ensuring the integrity of pipelines and umbilicals applied in reuse projects, providing the appropriate cathodic protection to these assemblies, commonly used in the oil and gas sector.

### BACKGROUND

Currently, flexible pipelines are supplied with specific anode split collars for assembly in their tubular body, having a fixed external diameter measurement, which ends up limiting the applicability of these collars.

Sometimes, these split collars are composed of parts that are difficult to handle, exposing the people involved in the installation (on board line laying vessels, typically known as “PLSV”—Pipe Laying Support Vessel) to safety risks and considerable assembly time.

In some situations, it is common in submarine interconnection projects to apply the pipeline reuse strategy. However, given the limitations in the design of current anodes, difficulties are faced in providing the cathodic protection necessary to guarantee the integrity of these reused pipelines. Due to the wide variety of external diameters of existing flexible pipelines, associated with the probabilistic nature of reuse projects and the long term usually required for the contracting and supply process of goods, it becomes difficult to create a strategic stock of anodes to meet projects for the reuse of pipelines or submarine umbilicals.

As previously mentioned, anode collars with a fixed internal diameter are currently used, even in pipeline reuse projects. However, due to this factor, the application of these anode collars becomes limited to the pipeline structure for which the collar was supplied, and it is not possible to reassign these collars to other pipelines with different diameters.

One of the solutions proposed in the state of the art to enable the reuse of anode collars in pipelines of different diameters consists of providing a set of anodes composed of anodes of different diameters and dimensions. However, in many cases, the anode selected with the outer diameter closest to the pipeline to be reused shows clearance during assembly, requiring adjustment for installation, such as using “filler” in the outer diameter of the pipeline, made with polypropylene cable and tape. This adjustment is less reliable and may cause the anode to come loose during the pipeline launch/installation, which poses a risk to the integrity of the subsea system as a whole. Furthermore, during the execution of this adjustment for assembly, carried out on board the PLSV vessel that installs the pipeline, there is a considerable increase in operating time (expenditure of critical resources—PLSV).

Therefore, there is a need in the state of the art for the development of a universal cathodic protection system that can be assembled in a wide variety of external pipe diameters, without being limited to a specific application restricted to a certain pipe diameter and using the same elements that make up the main assembly, without the need to adapt different elements from different systems and still having to resort to “filling” techniques in the external diameter of the pipe to adjust the installation.

### STATE OF THE ART

The search for the history led to some documents that disclose subject matters within the technological field of the present invention.

The document EP 0219472 A2 discloses anodes for protecting pipes against corrosion, especially oil pipes being unwound from a large diameter supply reel and laid on the seabed, each comprising a group of axially spaced elements attached to the pipe, the outermost elements of the group being connected to the pipe by welding to hold the intermediate elements in position, said elements being electrically connected to each other and to said outer elements by means of flexible connectors.

However, nowhere in the system disclosed in the document EP 0219472 A2 is an anode assembly suggested wherein each anode of the assembly has a polymeric base, a metal base, an anode containing eyelets and a threaded shaft for connecting the anode to an adjacent anode. Furthermore, the aforementioned document also does not mention using a closure to connect the anodes positioned at the ends, and in the system of EP 0219472 A2 the rows of anode ends are welded, which is not necessary in the present invention.

The document US 20050284771 A1, in its turn, discloses an apparatus and method for protecting a structure against corrosion, according to which the apparatus includes two members connected in an articulated manner, at least one anodic device connected to at least one of the members and a resilient component engaged in the members.

However, the device disclosed by the document US 20050284771 A1 has a general clamp format, which would make it difficult to adapt it to different pipe diameters.

The document U.S. Pat. No. 4,309,263 A discloses a clamping apparatus that is provided for use in clamping cathodic protection, single anodes, dual anodes, riser clamps and the like to offshore drilling rigs and the like in a marine environment. The apparatus provides a U-shaped channel for fitting against the surface of, for example, a rig leg with a first section extending angularly outward from the wall portion of the channel and a second section extending outward from the second wall of the channel. A chain screw connector is inserted into a hole provided in the first plate section with the chain wrapped around the drilling rig leg and the end chain links, then inserted into a keyhole in the extension of the second plate and locked by a movable plate. The nut screw is then tightened to clamp the apparatus against a rig leg. A clamping screw makes contact with the rig leg to complete the cathodic protection circuit. The clamping apparatus can support a single anode or a double anode or be used as a riser clamp on the leg of a drilling rig to prevent corrosion of the rig leg.

However, unlike the present invention, the apparatus of U.S. Pat. No. 4,309,263 A does not disclose or suggest a set of anodes having a polymeric base, a metal base and connection sections between different anodes. Furthermore, the aforementioned document discloses a device for cathodic protection essentially aimed at offshore platform legs, and not at flexible pipelines.

### BRIEF DESCRIPTION

Currently, there is a lack in the State of the Art of cathodic protection systems that allow the relocation of anodes between pipelines of different diameters, without having to resort to techniques of low reliability and/or efficiency, such as, for example, filling empty spaces between the external diameter of the pipeline and the anode.

In this sense, the present invention aims to develop a universal cathodic protection system consisting of an anode collar, which is assembled from different quantities of elements (links). This allows the system to be applied to a wide range of external diameters of pipelines and umbilicals, contributing to the viability of reuse projects.

Furthermore, economically, there is a strategic advantage in enabling a probabilistic demand contracting process, where it is possible to guarantee the supply of anodes that will be guaranteed to be used, even if it is not defined which pipeline (and its specific external diameter) will be used in the interconnection with reuse.

Additionally, because the cathodic protection system of the present invention is modular, the assembly of an anode system can be done on board a PLSV vessel in parallel with the pipeline launch and, for the assembly of the system in the pipeline, lifting points and eyelets with auxiliary equipment are provided, facilitating the work of onboard teams, reducing operating time and exposure to risks. This advantage of time reduction is also related to the fact that it is not necessary to use other implements to adapt the system of the present invention to the diameter of the pipeline, as is currently the case with the cathodic protection systems available in the State of the Art.

Thus, the advantages and objectives of the present invention are achieved by providing a universal cathodic protection system comprising: a set of links surrounding a portion of a pipeline; and a closure; wherein links of the set of links are connected in sequence to each other in a releasable manner to form an adjustable collar around the portion of the pipeline; wherein each link has a sacrificial anode to provide cathodic protection to the pipeline by means of electrical connection thereto; the closure being used to perform the locking and electrical continuity of the system around the pipeline by connecting to the two most extreme links of the set of links.

### BRIEF DESCRIPTION OF THE FIGURES

The preferred embodiments of the invention in question will be better understood when read in conjunction with the attached drawings. It must be understood, however, that the invention in question is not limited merely to the precise arrangements and instruments shown.

Thus, the present invention will be described below with reference to its typical embodiments and with reference to the attached drawings.

FIG. 1A shows a schematic view of a universal cathodic protection system comprising four links and a closure applied to a pipeline, according to an embodiment of the present invention.

FIG. 1B shows a top view of the universal cathodic protection system of FIG. 1A, according to an embodiment of the present invention.

FIG. 1C shows a detail “A” of the universal cathodic protection system of FIGS. 1A and 1B, according to an embodiment of the present invention.

FIG. 2A shows a schematic view of a universal cathodic protection system comprising fourteen links and a closure applied to a pipeline, according to an embodiment of the present invention.

FIG. 2B shows a top view of the universal cathodic protection system of FIG. 2A, according to an embodiment of the present invention.

FIG. 2C shows a detail “B” of the universal cathodic protection system of FIGS. 2A and 2B, according to an embodiment of the present invention.

FIG. 3B shows a top view of a link of the set of links of the universal cathodic protection system, according to an embodiment of the present invention.

FIG. 3A shows a front view of a link of the set of links of the universal cathodic protection system, according to an embodiment of the present invention.

FIG. 4A shows a schematic view of an anode in a horizontal position of the link of the universal cathodic protection system, according to an embodiment of the present invention.

FIG. 4B shows a bottom view of an anode in a horizontal position of the link of the universal cathodic protection system, according to an embodiment of the present invention.

FIG. 4C shows a front view of an anode in a horizontal position of the link of the universal cathodic protection system, according to an embodiment of the present invention.

FIG. 4D shows a right side view of an anode in a horizontal position of the link of the universal cathodic protection system, according to an embodiment of the present invention.

FIG. 5A shows a schematic view of a conduction base in a horizontal position of the link of the universal cathodic protection system, according to an embodiment of the present invention.

FIG. 5B shows a bottom view of a conduction base in a horizontal position of the link of the universal cathodic protection system, according to an embodiment of the present invention.

FIG. 5C shows a front view of a horizontally positioned conduction base of the universal cathodic protection system link, according to an embodiment of the present invention.

FIG. 5D shows a right side view of a horizontal conduction base of the link of the universal cathodic protection system, according to an embodiment of the present invention.

FIG. 6A shows a schematic view of a horizontal bulkhead base of the link of the universal cathodic protection system, according to an embodiment of the present invention.

FIG. 6B shows a bottom view of a horizontal bulkhead base of the link of the universal cathodic protection system, according to an embodiment of the present invention.

FIG. 6C shows a front view of a horizontal bulkhead base of the link of the universal cathodic protection system, according to an embodiment of the present invention.

FIG. 6D shows a right side view of a horizontal bulkhead base of the link of the universal cathodic protection system, according to an embodiment of the present invention.

FIG. 7 shows a front view of a threaded shaft of the link of the universal cathodic protection system, according to an embodiment of the present invention.

FIG. 8 shows a schematic front view of a closure connected to a threaded shaft of the link of the universal cathodic protection system, according to an embodiment of the present invention.

FIG. 9A shows a schematic front view of a rope with fastening means in its holes, according to an embodiment of the present invention.

FIG. 9B shows a front view of a rope without fastening means in its holes, according to an embodiment of the present invention.

### DETAILED DESCRIPTION

In the following, reference is made in detail to the preferred embodiments of the present invention illustrated in the accompanying drawings. Whenever possible, the same or similar reference numerals will be used throughout the drawings to refer to the same or similar features. It should be noted that the drawings are in simplified form and are not represented to an accurate scale, so that small variations are expected.

Initially, it should be noted that the words “duct(s)”, “pipe(s)”, “pipeline (s)”, “riser(s)”, and others, as used throughout the text of the present invention, should not be interpreted in a specific or limitative manner, but rather in a general manner, and are often used as synonyms to refer to any type of tubular structure for transporting hydrocarbons, widely used and known in the oil and gas sector.

The present invention relates to a universal cathodic protection system aimed at ensuring the integrity of pipelines and umbilicals applied in reuse projects, providing the appropriate cathodic protection to these assemblies, commonly used in the oil and gas sector.

Notably, the system of the present invention was designed to offer cathodic protection (corrosion protection) when attached to pipelines, umbilicals or other hydrocarbon transport accessories of varying external diameters. The system is composed of links assembled in sequence to form a collar, similar to a watch strap, thus allowing applications in pipelines of different external diameters. Each link has a sacrificial anode that will provide cathodic protection to the pipeline.

Furthermore, the system of the present invention will be applied in the area of subsea interconnection, specifically for the protection of pipelines and umbilicals, so that the flexible pipelines and umbilicals where the system is applied do not require any adaptation, suitability or filling for use.

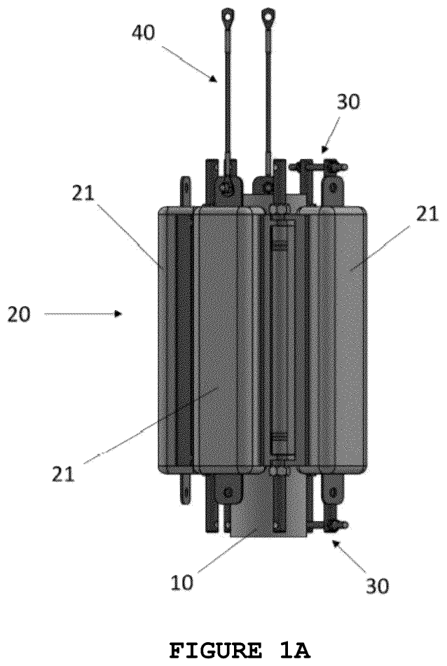

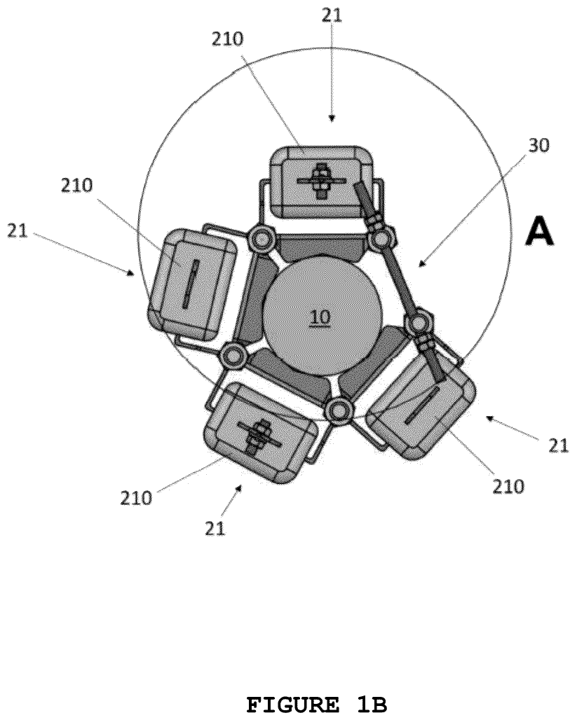

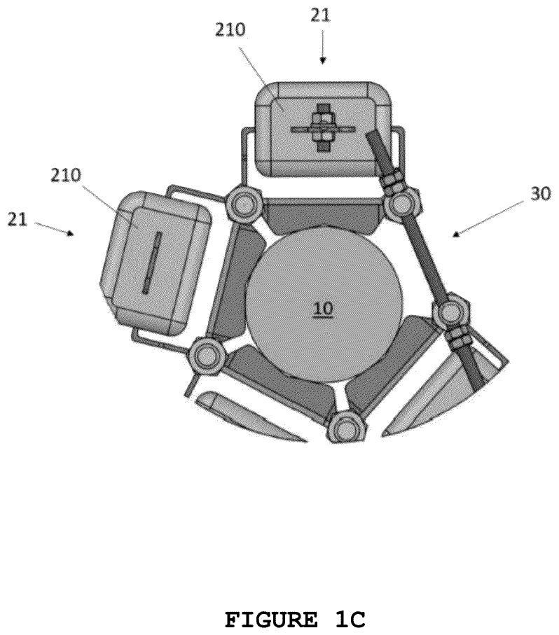

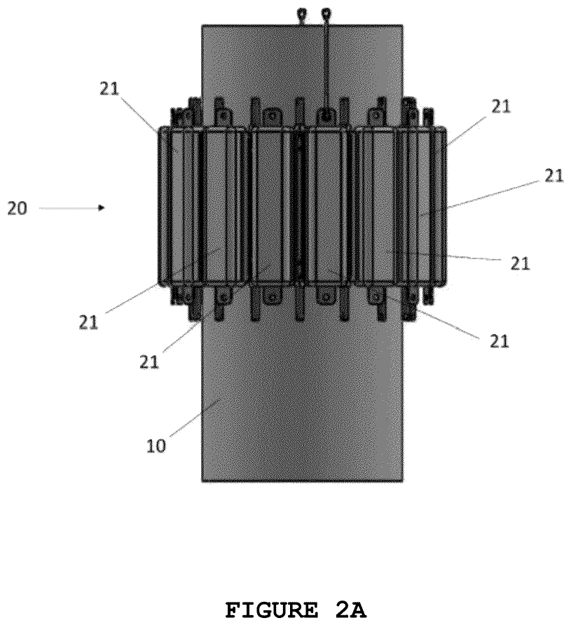

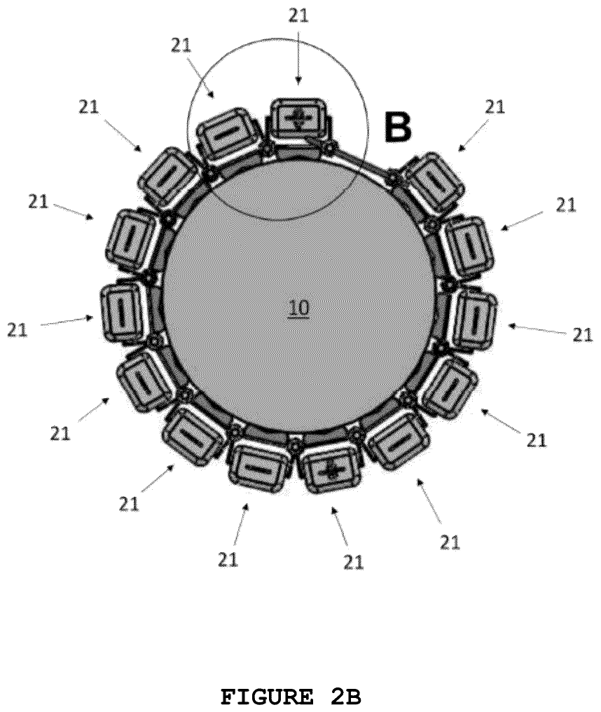

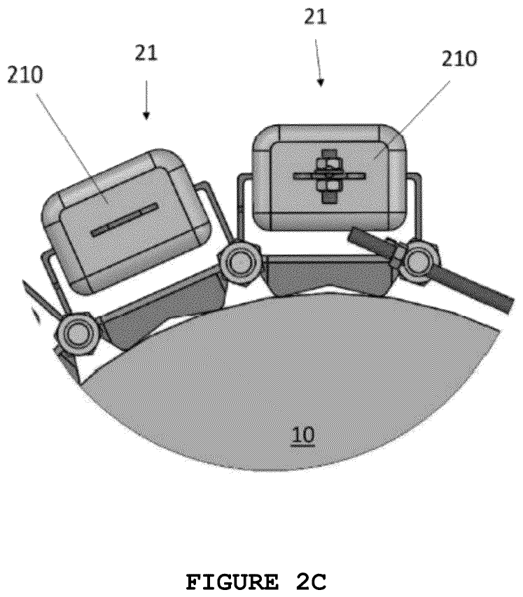

In this sense, reference is made to FIGS. 1A, 1B, 1C, 2A, 2B and 2C which show a universal cathodic protection system around a portion of a pipeline to protect the pipeline against corrosion, according to an embodiment of the present invention. In an embodiment of the present invention, the universal cathodic protection system comprises: a set of links 20 surrounding a portion of a pipeline 10; and a closure 30; wherein links 21 of the set of links 20 are connected in sequence to each other in a releasable manner to form an adjustable collar around the pipeline portion 10; wherein each link 21 has a sacrificial anode 210 to provide cathodic protection to the pipeline 10 by means of electrical connection thereto; the closure 30 being used to perform the locking and electrical continuity of the system around the pipeline 10 by connecting to the two most extreme links 21 of the set of links 20. According to the present invention, the collar formed by the set of links 20 is adjustable based on the addition or removal of links 21 to the set of links 20 to adapt to the external diameter of the pipeline 10.

FIGS. 1A, 1B and 1C show, by way of example, a pipeline 10 with an external diameter between approximately 100 mm and approximately 120 mm where the universal cathodic protection system is installed. For pipelines with an external diameter in this range, the set of links 20 comprises four links 21. In its turn, FIGS. 2A, 2B and 2C show a pipeline 10 with an external diameter between approximately 410 mm and approximately 440 mm where the universal cathodic protection system is installed. In this other configuration, the set of links 20 of the system comprises fourteen links 21. It is important to highlight that the dimension of each link 21 of the set of links 20 is maintained, regardless of the diameter of the pipeline 10, and only the number of links 21 of the set 20 will vary according to the external diameter of the pipeline 10, as previously mentioned. Thus, the number of links 21 of the universal cathodic protection system can be increased or decreased according to the external diameter of the pipeline 10 (d_ext) to allow the assembly of the set of links 20 around the portion of the pipeline 10 as shown in Table 1 (“Table 1—Quantity×External diameter (“d_ext”) of the pipeline) below:

TABLE 1

| | Quantity × d_ext of the pipeline | | | | | |
|---|---|---|---|---|---|---|
| | 100 mm ≤ | 120 mm < | 155 mm < | 190 mm < | 220 mm < | 255 mm < |
| Sub- | d_ext ≤ | d_ext ≤ | d_ext ≤ | d_ext ≤ | d_ext ≤ | d_ext ≤ |
| assembly | 120 mm | 155 mm | 190 mm | 220 mm | 255 mm | 290 mm |
| Set of links | 4 | 5 | 6 | 7 | 8 | 9 |
| [number | | | | | | |
| of links] | | | | | | |
| Closure | 1 | 1 | 1 | 1 | 1 | 1 |
| [number of | | | | | | |
| closures] | | | | | | |
| Anode mass | 20 | 25 | 30 | 35 | 40 | 45 |
| [Kg] | | | | | | |
| Total mass | 36 | 43 | 51 | 59 | 67 | 75 |
| [Kg] | | | | | | |

| | Quantity × d_ext of the pipeline | | | | | |
|---|---|---|---|---|---|---|
| | 290 mm < | 320 mm < | 350 mm < | 380 mm < | 410 mm < | 440 mm < |
| Sub- | d_ext ≤ | d_ext ≤ | d_ext ≤ | d_ext ≤ | d_ext ≤ | d_ext ≤ |
| assembly | 320 mm | 350 mm | 380 mm | 410 mm | 440 mm | 470 mm |
| Set of links | 10 | 11 | 12 | 13 | 14 | 15 |
| [number | | | | | | |
| of links] | | | | | | |
| Closure | 1 | 1 | 1 | 1 | 1 | 1 |
| [number of | | | | | | |
| closures] | | | | | | |
| Anode mass | 50 | 55 | 60 | 65 | 70 | 75 |
| [Kg] | | | | | | |
| Total mass | 83 | 90 | 98 | 106 | 114 | 122 |
| [Kg] | | | | | | |

Additionally, according to the system of the present invention, multiple sets of links 20 can be used in series to achieve the anodic mass required for protection throughout the useful life of a subsea application. The anodic mass per size of set of links 20 and closure 30 also varies according to Table 1. It should be noted that, although the table shows the variation in the number of system elements (links and closure) according to the diameter of the pipeline ranging from 100 mm to 470 mm, a system can contain less than four or more than fifteen links, for diameters below 100 mm or above 470 mm, respectively. A person skilled in the art will notice, from the values shown in the table, that for each variation range of external diameter of pipeline 10 (d_ext) of 30 mm, a link 21 must be added to the set of links 20.

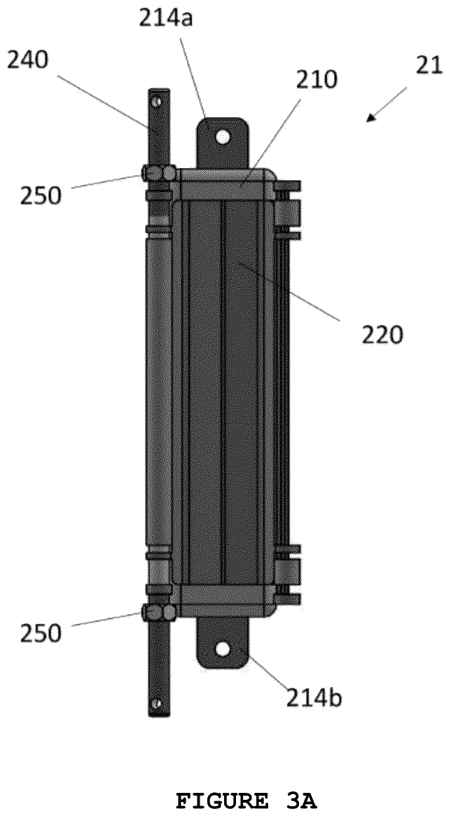

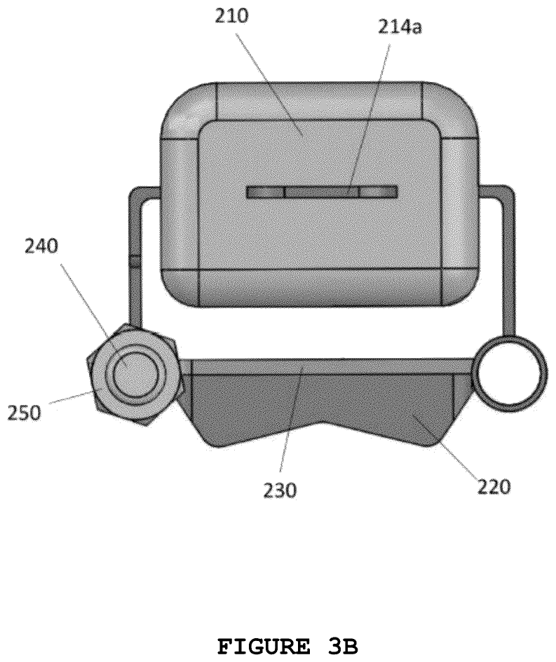

FIGS. 3A and 3B show a link 21 of the set of links 20, according to an embodiment of the present invention. Each link 21 comprises: a bulkhead base 220, being a polymeric base, preferably polyurethane; a conduction base 230, being a metallic base formed from a metal sheet, preferably stainless steel; an anode 210 having a body in the general shape of a parallelepiped manufactured from an aluminum alloy; a threaded shaft 240 and fastening means 250.

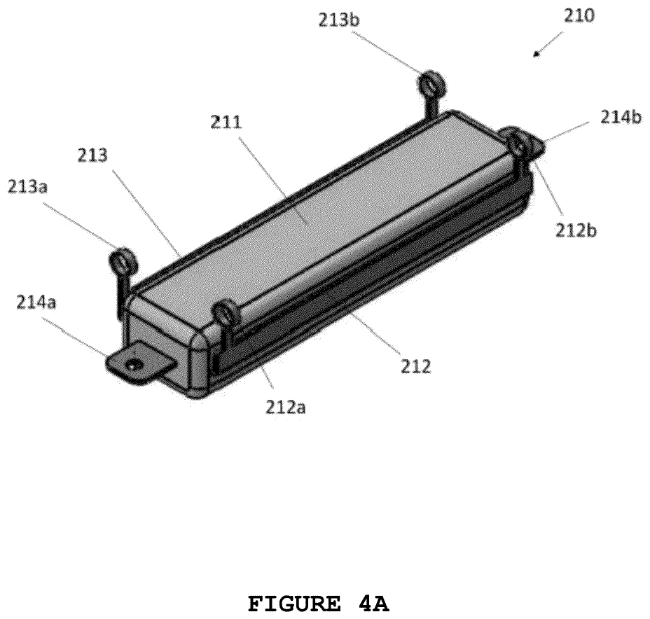

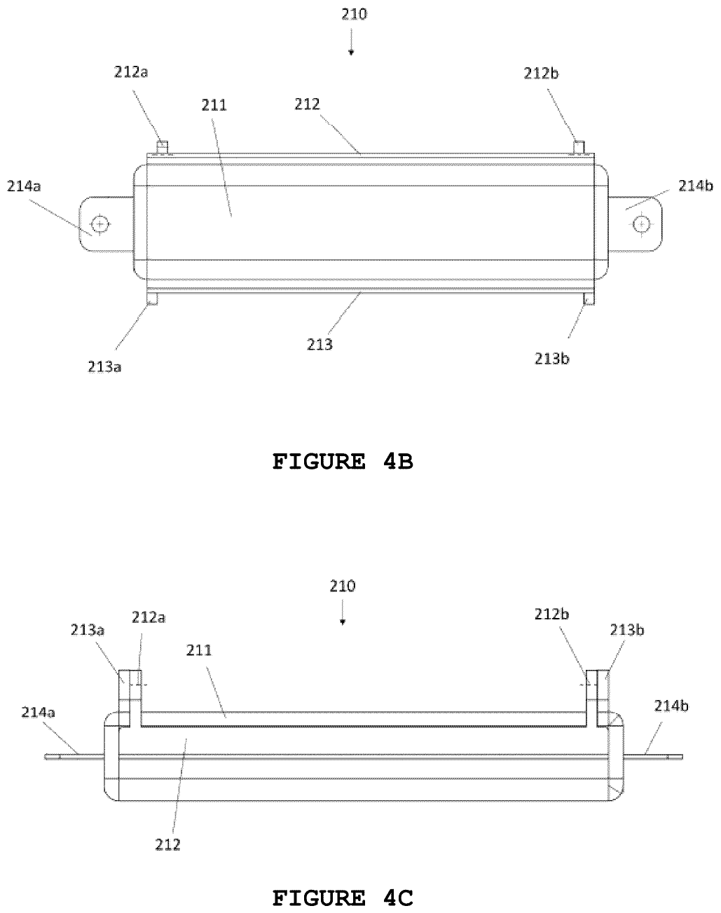

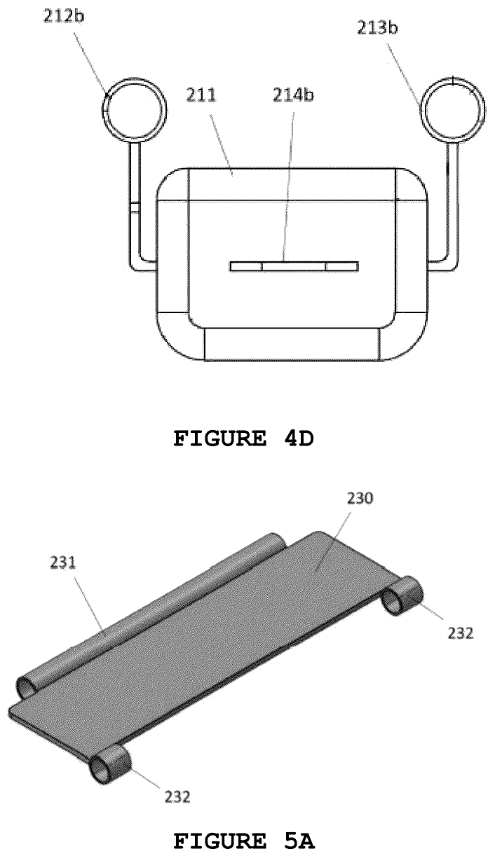

Thus, FIGS. 4A, 4B, 4C and 4D show an anode 210 of the set of links 20, according to an embodiment of the present invention. As mentioned, the anode 210 has a body 211 in the general shape of a parallelepiped and two side plates 212, 213 each arranged on one side of the body 211. In addition, each side plate 212, 213 extends along the longitudinal direction of the anode 210 and has two alignment rings 212a, 212b; 213a, 213b that extend forward of anode 210, being an upper alignment ring 212a and a lower alignment ring 212b of a first side plate 212 and an upper alignment ring 213a and a lower alignment ring 213b of a second side plate 213. As can be seen, the center of each upper ring 212a, 213a is aligned with the center of its respective lower ring 212b, 213b.

Further, as shown by FIGS. 4B and 4C, the upper alignment ring 213a and the lower alignment ring 213b of the second side plate 213 are located at opposite ends and at the threshold of said side plate 213. In its turn, the upper alignment ring 212a and the lower alignment ring 212b of the first side plate 212 are located at opposite ends and before reaching the threshold of said first side plate 212, so that the distance between the upper alignment ring 212a and the lower alignment ring 212b of the first side plate 212 is smaller than the distance between the upper alignment ring 213a and the lower alignment ring 213b of the second side plate 213.

In other embodiments of the present invention, the upper alignment ring 212a and the lower alignment ring 212b of the first side plate 212 are located at opposite ends and at the threshold of said side plate 212. In its turn, the upper alignment ring 213a and the lower alignment ring 213b of the second side plate 213 are located at opposite ends and before reaching the threshold of said second side plate 213, so that the distance between the upper alignment ring 213a and the lower alignment ring 213b of the second side plate 213 is smaller than the distance between the upper alignment ring 212a and the lower alignment ring 212b of the first side plate 212.

Based on the previous description, it can be noted that the connection of a link 21 by the side of its first side plate 212 to an adjacent link 21 by the side of its second side plate 213 becomes possible since there will be no interference between the upper links 212a, 213a and between the lower links 212b, 213b at the time of connection. In other words, at the time of connection between adjacent links 21, the upper alignment ring 212a of a first side plate 212 of a first link 21 is positioned above or below an upper alignment ring 213a of a second side plate 213 of a second link 21, adjacent to the first link 21. Likewise, at the time of connection between adjacent links 21, the lower alignment ring 212b of a first side plate 212 of a first link 21 is positioned above or below a lower alignment ring 213b of a second side plate 213 of a second link 21, adjacent to the first link 21.

In embodiments of the present invention, the anode 210 further comprises a lower eyelet 214b and an upper eyelet 214a for receiving a lifting element, thereby facilitating the lifting element to be fitted into the eyelet 214a, 214b and allow lifting the set of links 20, facilitating handling of the system on board the vessel, reducing exposure to risk for people involved in assembly and installation in the pipelines. As understood by a person skilled in the art, the anodes 210 act as sacrificial anodes to protect the pipeline 10 against corrosion, since this occurs primarily in the anodes 210, when the electric current that runs through the circuit through the metal connections of the system flows from the set of anodes to the cathode (pipeline). Furthermore, when the link 21 is assembled, the anode 210 is arranged in the rear portion of the link 21.

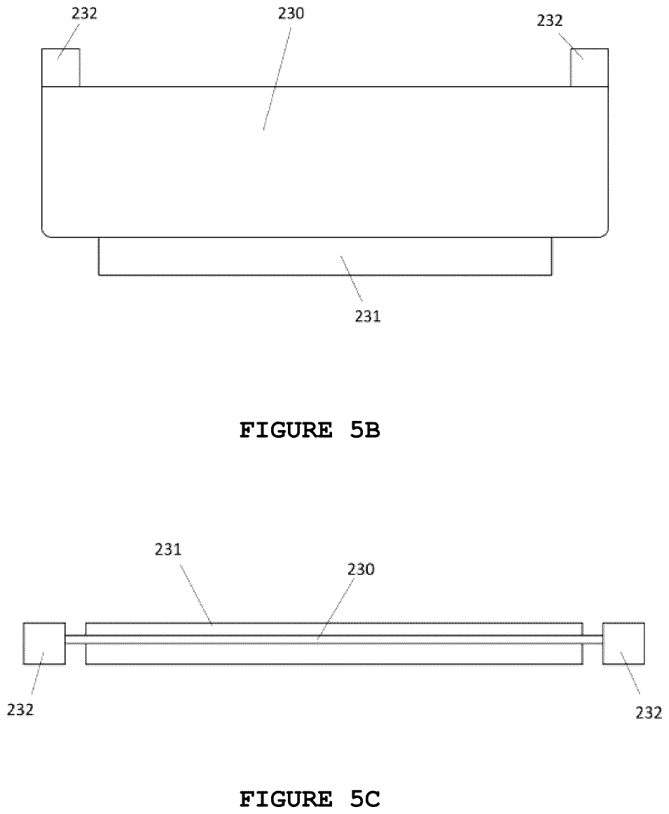

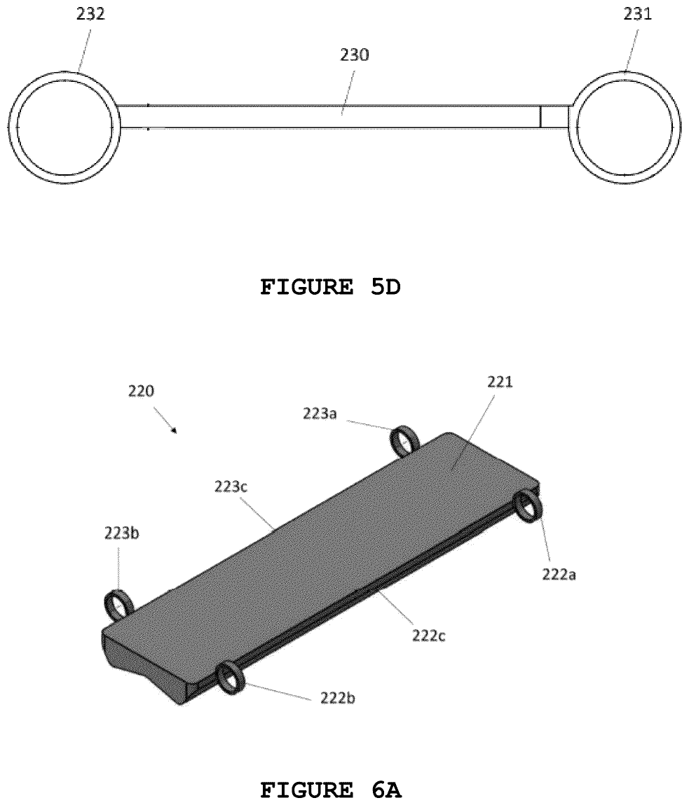

FIGS. 5A, 5B, 5C and 5D show a conduction base 230 of a link 21 of the set of links 20, according to an embodiment of the present invention. The conduction base 230 has the function of conducting electrons throughout the system and is a metal base manufactured from steel, preferably stainless steel. Furthermore, the conduction base 230 has a general rectangular shape, having an alignment channel 231 on one of its sides and two fitting portions 232 on the opposite side. The alignment channel 231 is a tubular structure arranged longitudinally on one side of the conduction base 230 and through which a threaded shaft 240 passes. The alignment channel 231 is completely enclosed around it to protect and guide the threaded shaft 240 and, also, to promote the transmission of electrons along its entire length. Additionally, each fitting portion 232 of the driving base 230 has an annular shape and is arranged at one end of the side opposite to the side where the alignment channel 231 is arranged. Each fitting portion 232 has its center aligned in relation to the other, so as to guide a threaded shaft 240 that passes through them.

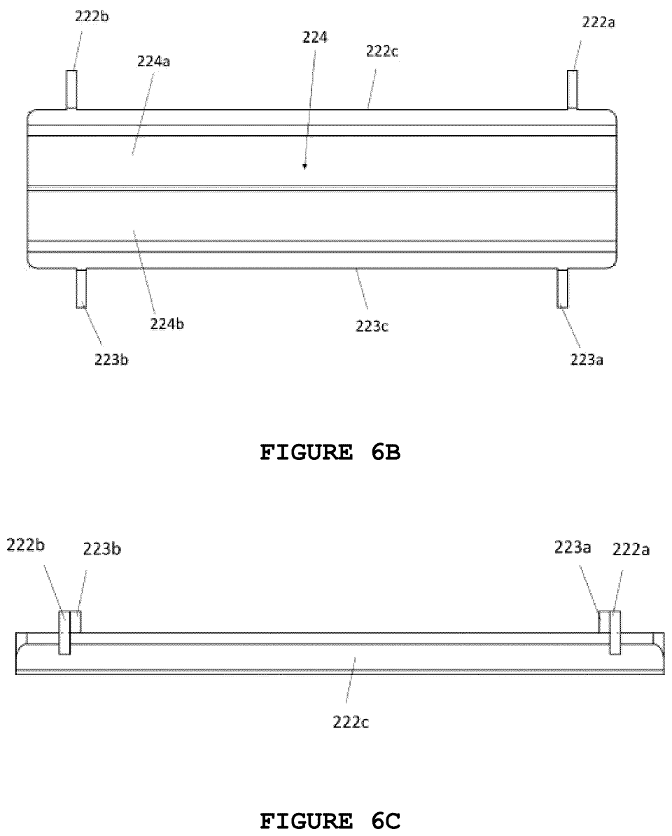

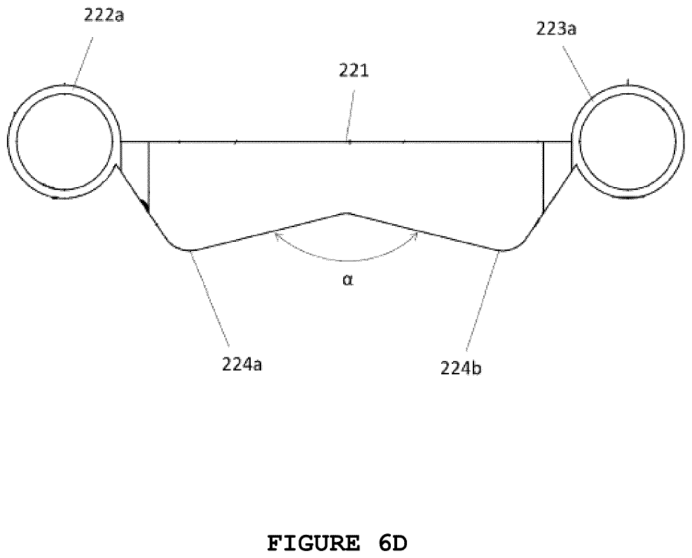

FIGS. 6A, 6B, 6C and 6D show a bulkhead base 220 in accordance with an embodiment of the present invention. The bulkhead base 220 has its rear portion 221 substantially flat for joining with the conduction base 230. Furthermore, the bulkhead base 220 further includes a first ring 222a and a second ring 222b disposed on a first side 222c of the bulkhead base 220; and a first ring 223a and a second ring 223b disposed on a second side 223c of the bulkhead base 220, wherein the rings 222a, 222b of the first side 222c align with the alignment channel 231 of the conduction base 230 and with the alignment rings 212a, 212b of the anode 210; and the rings 223a, 223b of the second side 223c align with the two fitting portions 232 of the conduction base 230 and with the alignment rings 213a, 213b of the anode 210. Additionally, the bulkhead base 220 also has a front portion 224 having two protrusions 224a, 224b forming a valley between them, so that the valley formed includes an angle α greater than 90°, preferably between approximately 90° and approximately 160°, more preferably between approximately 140° and approximately 160°, even more preferably approximately 152°.

It should be noted that the bulkhead base 220 aims to preserve the integrity of the duct or umbilical cover, standardizing the tension during contact in installation and operation. Thus, each link 21 contacts part of the surroundings of the pipeline 10 through the front portion 224 of the bulkhead base 220 of the link 21, wherein the two protuberances 224a, 224b contact or fit into the curvature of the pipeline 10, protecting that region, as shown in FIGS. 1A to 2C.

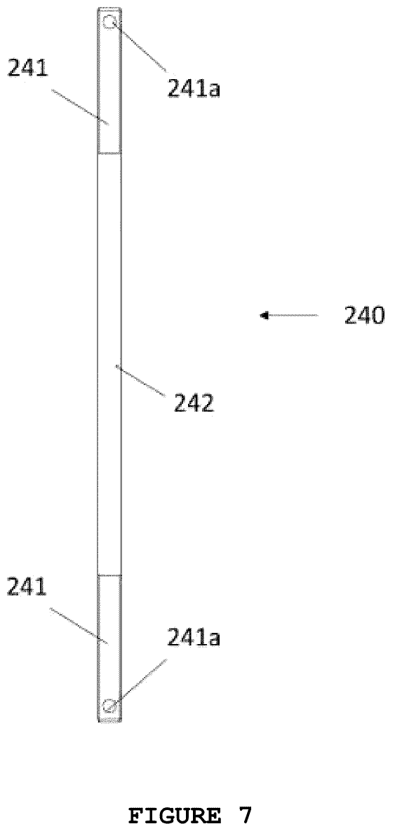

Furthermore, the link 21 has a threaded shaft 240, as can be seen in FIGS. 3A to 3C and, in more detail, in FIG. 7. The threaded shaft 240 has two threaded portions 241 at its ends separated by a smooth (without threads) central portion 242. Each threaded portion 241 has a hole 241a near its distal end for fitting a lifting element, so as to facilitate handling of the system, or of a lanyard of the closure 30. As should be noted, the threaded shaft 240 joins a first link 21 to a second link 21 of the set of links 20, adjacent to the first link 21, by passing through the alignment collars 212a, 212b, the alignment channel 231 and the rings 222a, 222b of the first link 21, and the alignment collars 213a, 213b, fitting portions 232 and rings 223a, 223b of the second link 21, all with their centers aligned with each other. Additionally, threads 250 are engaged in the threaded portions 241 of the threaded shaft 240 to securely hold the connecting links 21.

Although the previous description was made for a first and a second link, the form of connection between adjacent links to form the set of links 20 around the pipeline portion 10 is repeated between the second and third link, between the third link and the fourth link, between the fourth link and the fifth link and so on until the last link of the set, which connects to the first link by means of the lock. Furthermore, the connection between the links 21 can be made in a clockwise or counterclockwise direction. It is also worth noting that the threaded shaft 240 and the nuts 250 are made of steel, preferably stainless steel.

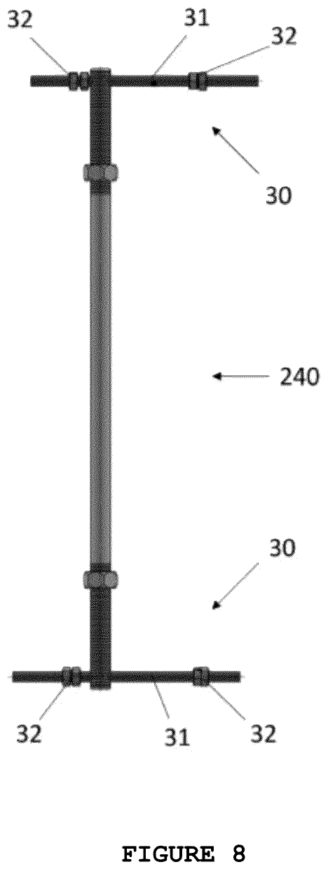

FIG. 8 shows, by way of example, a closure 30 of the universal cathodic protection system, according to an embodiment of the present invention. For ease of description, the closure 30 shown in FIG. 8 connects to only one threaded shaft 240. However, it should be noted that the closure 30 connects a threaded shaft 240 of the first link 21 to another threaded shaft 240 of the last link 21 of the set of links. In this sense, in one embodiment of the present invention, the closure 30 comprises two housings 31 that are fitted into the holes 241a of the threaded portions 241 of the threaded shafts 240. To securely fasten the housings 31 to the threaded shafts 240, nuts 32 are used on the housings 31.

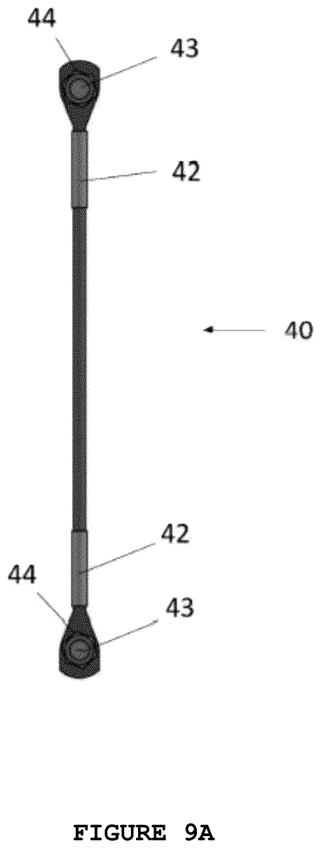

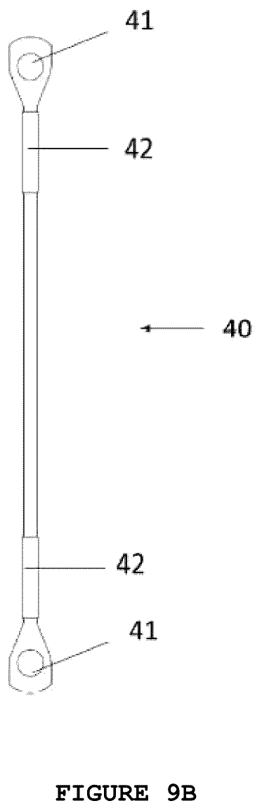

In one embodiment of the present invention, the universal cathodic protection system further comprises one or more ropes 40, as shown in FIGS. 9A and 9B, preferably made of copper. Each rope 40 has holes 41 at its ends for fitting sleeves 43 and nuts 44, which securely connect the rope 40 to an eyelet 214a, 214b of an anode 210. Thus, a rope 40 can be connected to an eyelet 214a, 214b of an anode 210 of a set of links 20 by one of its ends and to an eyelet 214a, 214b of another anode 210 that belongs to another set of links 20 above or below. The rope 40 acts to conduct the electric current through the sets of links 20 and closures 30 of the universal cathodic protection system. Furthermore, the ends of the rope 40 are protected with heat-shrinkable covers 42 arranged close to the ends of the rope 40.

Those skilled in the art will appreciate the knowledge being shown and will be able to reproduce the invention in the embodiments indicated and in other variants, covered by the scope of the attached claims.

1- A universal cathodic protection system comprising:
a set of links surrounding a portion of a pipeline; and
a closure;
wherein links of the set of links are connected in sequence to each other in a releasable manner to form an adjustable collar around the portion of the pipeline;
wherein each link has a sacrificial anode to provide cathodic protection to the pipeline via an electrical connection thereto;
the closure being used to perform the locking and electrical continuity of the system around the pipeline by connecting to the two most extreme links of the set of links.

2- The system according to claim 1, wherein the collar formed by the set of links is adjustable based on the addition or removal of links to the set of links to adapt to the external diameter of the pipeline.

3- The system according to claim 1, wherein each link comprises:
an anode comprising:
a body in the general shape of a parallelepiped made from an aluminum alloy;
two side plates each arranged on one side of the body; and
one or more eyelets for receiving a lifting element.

4- The system according to claim 3, wherein each side plate extends along the longitudinal direction of the anode and has two alignment rings that extend towards the front of the anode, being an upper alignment ring and a lower alignment ring of a first side plate and an upper alignment ring and a lower alignment ring of a second side plate.

5- The system according to claim 4, wherein the distance between the upper alignment ring and the lower alignment ring of the first side plate is smaller or larger than the distance between the upper alignment ring and the lower alignment ring of the second side plate.

6- The system according to claim 1, wherein each link further comprises:
a driving base, being a metal base formed from a metal sheet, wherein the metal sheet comprises stainless steel.

7- The system according to claim 6, wherein the driving base has a general rectangular shape, having an alignment channel on one of its sides and two fitting portions on the opposite side.

8- The system according to claim 7, wherein the alignment channel is a tubular structure arranged longitudinally on one side of the conduction base and through which a threaded shaft passes, the alignment channel being closed around it to protect and guide the threaded shaft and also promote the transmission of electrons along its entire length.

9- The system according to claim 7, wherein each fitting portion of the conduction base has a ring shape and is arranged at one end of the side opposite to the side where the alignment channel is arranged, each fitting portion has its center aligned in relation to the other, so as to guide a threaded shaft that passes through them.

10- The system according to claim 1, wherein each link further comprises:
a bulkhead base, being a polymeric base, preferably polyurethane.

11- The system according to claim 10, wherein the bulkhead base has its rear portion flat for joining with the conduction base.

12- The system according to claim 10, wherein the bulkhead base further includes a first ring and a second ring arranged on a first side of the bulkhead base; and
a first ring and a second ring arranged on a second side of the bulkhead base.

13- The system according to claim 12, wherein the rings of the first side align with the alignment channel of the conduction base and with the alignment rings of the anode; and
the rings of the second side align with the two fitting portions of the conduction base and with the alignment rings of the anode.

14- The system according to claim 10, wherein the bulkhead base further has a front portion having two protuberances forming a valley between them, so that the valley formed includes an angle between the two protuberances of greater than 90°.

15- The system according to claim 1, wherein each link has a threaded shaft having two threaded portions at its ends separated by a smooth central portion.

16- The system according to claim 15, wherein each threaded portion has a hole close to its distal end for fitting a lifting element or a closure cord.

17- The system according to claim 1, wherein a threaded shaft joins a first link to a second link of the set of links, adjacent to the first link, by passing through first alignment collars, an alignment channel and rings of the first link, and second alignment collars, engagement portions and rings of the second link, all with their centers aligned with each other.

18- The system according to claim 17, wherein threads are fitted into threaded portions of the threaded shaft to securely hold the links of the connection.

19- The system according to claim 18, wherein the closure comprises two sleeves that are fitted into holes of the threaded portions of the threaded shaft.

20- The system according to claim 1, further comprising one or more ropes, each rope having holes at its ends for fitting sleeves and nuts, which securely connect the rope to an eyelet of an anode.
